(19) United States
(12) Patent Application Publication
(10) Pub. No.: US 2022/0181953 A1
(43) Pub. Date: Jun. 9, 2022

(54) SLOT WEDGE AND METHOD THAT USES THE SAME

(71) Applicant: Schaeffler Technologies AG & Co. KG, Herzogenaurach (DE)

(72) Inventor: Fabian Oehler, Wachenheim (DE)

(73) Assignee: Schaeffler Technologies AG & Co. KG, Herzogenaurach (DE)

(21) Appl. No.: 17/441,299

(22) PCT Filed: Mar. 6, 2020
(86) PCT No.: PCT/DE2020/100155

§ 371 Date: Sep. 21, 2021

(30) Foreign Application Priority Data
Mar. 25, 2019 (DE) 10 2019 107 537.8

(51) Int. Cl. H02K 15/00; H02K 15/10; H02K 3/487

(52) U.S. Cl. CPC H02K 15/0018; H02K 3/487; H02K 15/10

(57) ABSTRACT

A slot wedge having a stem region and an engagement region perpendicular thereto radially closes a slot in an electrical machine. The engagement region is in engagement with deformed regions of a slot insulation material. A closure cap can fasten the slot wedge in the slot. Protrusions which limit a creepage distance can be provided on the stem region or on a possible closure cap.

### CROSS-REFERENCE TO RELATED APPLICATIONS

This application is the U.S. National Phase of PCT Appln. No. PCT/DE2020/100155 filed Mar. 6, 2020, which claims priority to DE 102019107537.8 filed Mar. 25, 2019, the entire disclosures of which are incorporated by reference herein.

### TECHNICAL FIELD

The disclosure relates to electrical machines and, more precisely, to the design of the closure of slots for the windings of an electrical machine.

### BACKGROUND

Various winding techniques are known in connection with the windings of electrical machines. In the development of high-performance electric motors, for example, the wave winding offers advantages in terms of the achievable power compared to a concentrated winding, and advantages in terms of the required number of welded joints and in terms of skin and proximity effects compared to a hairpin design. The problem with an electrical machine having a wave winding is the slot closure, that is to say the closure of the slots that accommodate the windings of the electrical machine in the stator or rotor. Due to the high voltage acting in the electrical machine and also the relevant regulations, such a slot closure is necessary, but not easy to implement due to the radial introduction of the windings into the slot.

It is known, for example, to introduce windings radially from the inside into the slots of a stator of an electrical machine. The slots are initially open to the air gap of the electrical machine. If the slots remain open, it is more difficult to maintain the required distances from the high-voltage insulation; this also reduces the overall insulation of the electrical machine. This is counteracted by closing the slots with slot wedges.

The previous closing of the opening of a slot with a conventional slot wedge is not free from problems. First of all, a sufficient overlap between the slot wedge and the actual slot insulation material must always be ensured. This is especially difficult in applications with a large number of slots and thus very narrow slots, since the slot insulation material, such as paper, would sometimes need to be laid several times over the entire width of the slot to achieve the distances required for high-voltage insulation. The subsequent closing of the slot with the previously introduced slot insulation material also poses a problem, since deformation of the slot insulation material in a narrow slot is usually not possible in a series process.

### SUMMARY

The object is therefore to specify a slot wedge which enables a reliable closure of a slot in a simple manner.

A corresponding method should also be specified.

The object with regard to the slot wedge is achieved by a slot wedge as described herein.

The object with regard to the method is achieved by a method as described herein.

The claims and description below contain advantageous configurations.

The slot wedge according to the disclosure has a stem region and an engagement region perpendicular to the stem region. If the slot wedge is inserted into a slot, the stem region points in the radial direction with respect to the electrical machine, and thus in the direction in which the slot extends. The engagement region perpendicular to the stem region is provided to engage with slot insulation material in the slot, that is to interlock therewith. In this way, a reliable closure of the slot is ensured and also sufficient overlap with the slot insulation material.

In one embodiment, the engagement region is designed to be plate-shaped. A plate-shaped design increases tolerances for a secure engagement with the slot insulation material and makes the closure of the slot by the slot wedge more reliable.

In one embodiment, a closure cap is provided on the stem region. The closure cap is spaced apart from the engagement region. While the engagement region in the interior of the slot comes into engagement with the slot insulation material, the closure cap closes the slot to the outside, that is to say against the air gap of the electrical machine.

The slot wedge can be designed in such a way that the distances required for high-voltage insulation are guaranteed in a simple and reliable manner by defining a sufficiently long creepage distance through the slot wedge. If the slot wedge has a closure cap, corresponding protrusions, which limit such a creepage distance, can be formed on the closure cap for this purpose. Alternatively, protrusions can be provided on the stem region which limit such a creepage distance. A combination of the two options just mentioned is also conceivable.

The method according to the disclosure serves to close a slot after a winding has been introduced into the slot and uses a slot wedge according to the disclosure as described above. The method performs at least the following steps.

First, a slot insulation material is introduced into the slot. This is followed by the introduction of the winding into the slot. The slot insulation material is then deformed in such a way that at least two opposite regions of the slot insulation material are directed towards a central axis of the slot; the central axis runs in the radial direction with respect to the electrical machine. A slot wedge according to the disclosure is then introduced into the slot. This is done in such a way that the engagement region of the slot wedge is in engagement with the at least two opposite regions of the slot insulation material that were generated by the previous deformation of the slot insulation material. This can be done, for example, in such a way that initially the regions formed by the deformation of the slot insulation material are still held outside the slot, the engagement region is brought into engagement with the deformed slot insulation material in the axial direction, i.e., perpendicular to the radial extent of the slot, and slot insulation material and slot wedge are then brought together in the intended position in the slot. Alternatively, a sufficiently elastic slot insulation material can be used, the engagement region is inserted into the slot, the deformed slot insulation material initially also presses into the interior of the slot before the slot insulation material springs back and thus gets behind the engagement region, whereby the engagement region is then in engagement with the slot insulation material.

In one embodiment, the slot wedge has a closure cap. When the slot wedge is introduced into the slot, the slot wedge is fastened by the closure cap, in particular laterally, that is, perpendicular to the central axis of the slot.

If protrusions are provided on the closure cap or on the stem region, the slot wedge inserted into the slot defines a creepage distance in the slot through these protrusions.

The slot wedge can be made from a plastic, for example polyphenylene sulfide (PPS), preferably in one piece. A more elastic plastic also favors the radial insertion of the slot wedge into the slot, since the engagement region can then also be elastically deformed when it is passed through the deformed region of the slot insulation material to then spring back and thus interlock with the slot insulation material.

### BRIEF DESCRIPTION OF THE DRAWINGS

The disclosure and the advantages thereof are explained in more detail below with reference to the accompanying schematic drawings.

FIG. 1 shows a first exemplary embodiment of a slot wedge according to the disclosure.

FIG. 2 shows the exemplary embodiment from FIG. 1 in a top view.

FIG. 3 shows a second exemplary embodiment of a slot wedge according to the disclosure.

FIG. 4 shows the exemplary embodiment from FIG. 3 in a top view.

FIG. 5 shows an example of the closure of a slot according to the disclosure.

FIG. 6 shows another example of the closure of a slot according to the disclosure.

The drawings merely represent exemplary embodiments of the disclosure and are therefore not to be construed as limiting the disclosure to the exemplary embodiments shown.

### DETAILED DESCRIPTION

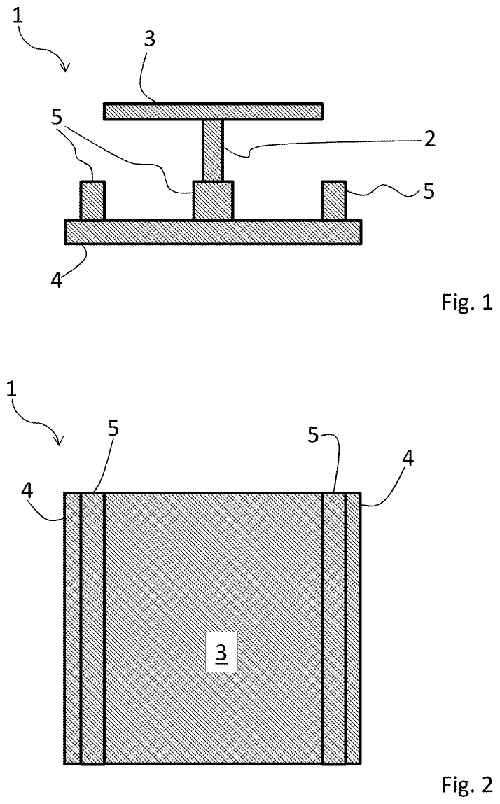

FIG. 1 shows an exemplary embodiment of a slot wedge 1 according to the disclosure. The slot wedge 1 has a stem region 2 and an engagement region 3 perpendicular thereto. In the example shown, the slot wedge 1 has a closure cap 4 which is attached to the stem region 2 and on which protrusions 5 are formed which serve to limit a creepage distance in a slot.

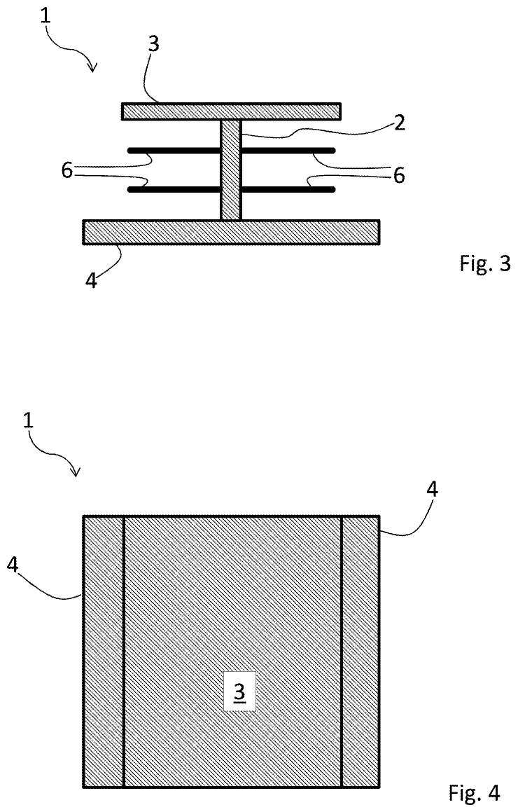

FIG. 2 shows the slot wedge 1 from FIG. 1 in a top view. The elements shown have already been explained in connection with FIG. 1. As can be seen here, the engagement region 3 is plate-shaped.

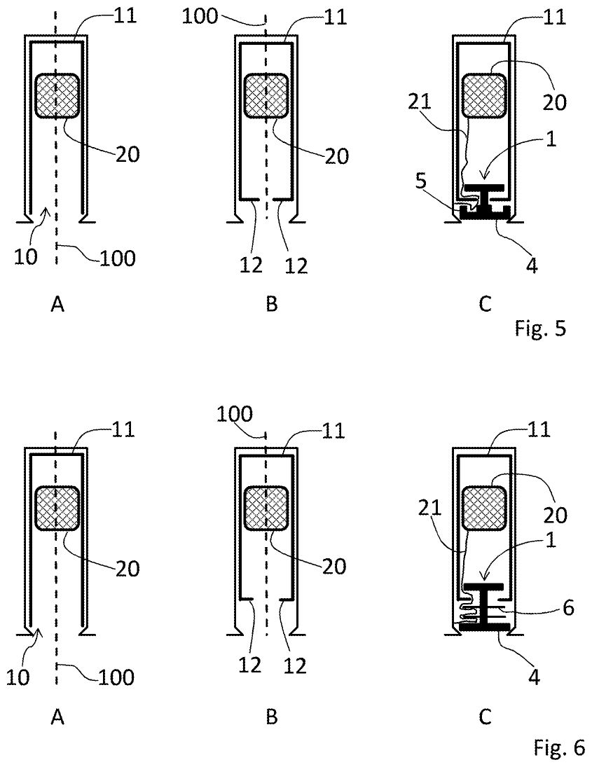

FIG. 3 shows a further exemplary embodiment of a slot wedge 1 according to the disclosure. The slot wedge 1 has a stem region 2 and an engagement region 3 perpendicular thereto. In the example shown, the slot wedge 1 has a closure cap 4 attached to the stem region 2. In the example shown, protrusions 6 are provided on the stem region 2, which serve to limit a creepage distance in a slot.

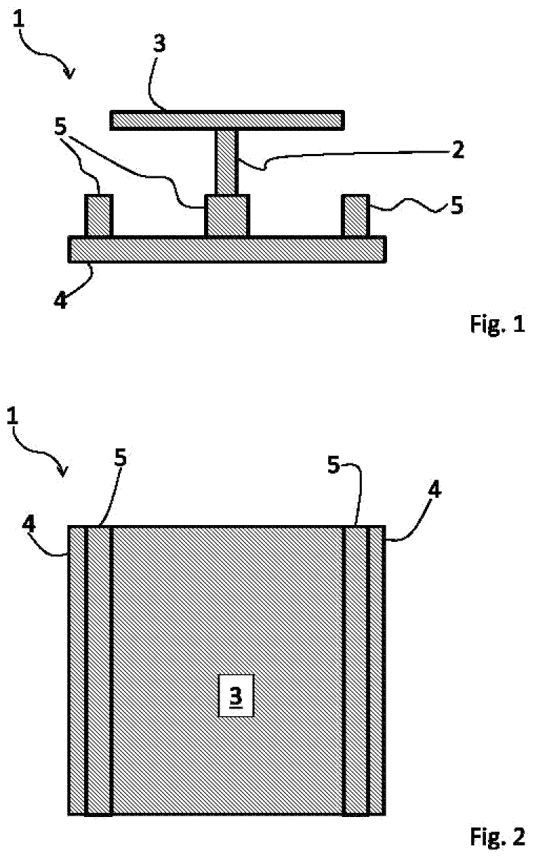

FIG. 4 shows the slot wedge 1 from FIG. 3 in a top view. The elements shown have already been explained in connection with FIG. 3. As can be seen here, the engagement region 3 is plate-shaped.

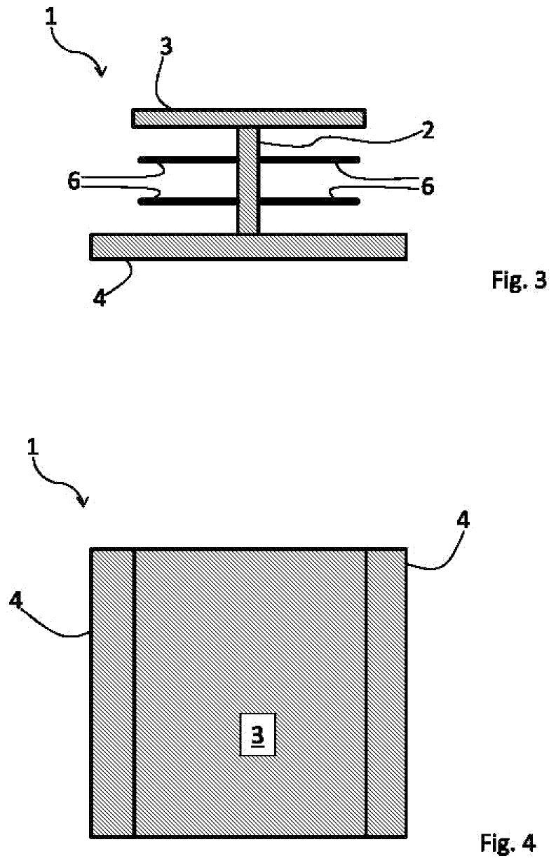

FIG. 5 shows stages of the closure of a slot 10 in connection with the introduction of a winding 20 into the slot 10. A slot 10 and the central axis 100 thereof are shown. The central axis 100 extends in the radial direction with respect to an electrical machine in the stator or rotor of which the slot 10 is provided; that is, the axis of rotation of the rotor of the electrical machine is perpendicular to the plane of the drawing. In stage A, a slot insulation material 11 is introduced into the slot 10, and a winding 20 is already arranged in the slot 10. In stage B, the slot insulation material 11 is deformed in such a way that regions 12 of the slot insulation material 11 are directed towards the central axis 100. In stage C, a slot wedge 1 of the type shown in FIG. 1 is inserted into the slot 10. Also shown schematically is a creepage distance 21 which is delimited by the protrusions 5 on the slot wedge 1. In the exemplary embodiment shown, the opening of the slot 10 is narrowed relative to the diameter of the slot 10. As a result, the closure cap 4 and thus the entire slot wedge 1 is held in the slot 10. However, it is also conceivable that there is no narrowing of the slot, but that the slot has a constant diameter, for example. In this case, the slot wedge could be held in the slot with a friction fit.

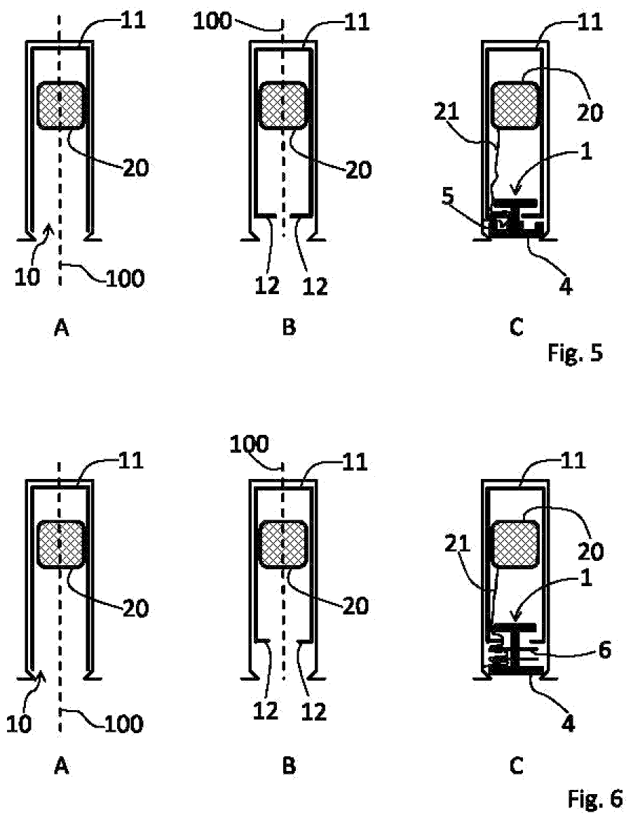

FIG. 6 shows stages of the closure of a slot 10 in connection with the introduction of a winding 20 into the slot 10. A slot 10 and the central axis 100 thereof are shown. The central axis 100 extends in the radial direction with respect to an electrical machine in the stator or rotor of which the slot 10 is provided; that is, the axis of rotation of the rotor of the electrical machine is perpendicular to the plane of the drawing. In stage A, a slot insulation material 11 is introduced into the slot 10, and a winding 20 is already arranged in the slot 10. In stage B, the slot insulation material 11 is deformed in such a way that regions 12 of the slot insulation material 11 are directed towards the central axis 100. In stage C, a slot wedge 1 of the type shown in FIG. 3 is inserted into the slot 10. Also shown schematically is a creepage distance 21 which is delimited by the protrusions 6 on the slot wedge 1. In the exemplary embodiment shown, the opening of the slot 10 is narrowed relative to the diameter of the slot 10. As a result, the closure cap 4 and thus the entire slot wedge 1 is held in the slot 10. However, it is also conceivable that there is no narrowing of the slot, but that the slot has a constant diameter, for example. In this case, the slot wedge could be held in the slot with a friction fit.

### LIST OF REFERENCE NUMBERS

1 Slot wedge
2 Stem region
3 Engagement region
4 Closure cap
5 Protrusions
6 Protrusions
10 Slot
11 Slot insulation material
12 Region (of the slot insulation material)
20 Winding
21 Creepage distance
100 Central axis (of the slot)

1. A slot wedge having a stem region and an engagement region perpendicular to the stem region.

2. The slot wedge according to claim 1, wherein the engagement region is plate-shaped.

3. The slot wedge according to claim 1, wherein a closure cap is provided on the stem region.

4. The slot wedge according to claim 3, wherein protrusions which limit a creepage distance are provided on the closure cap.

5. The slot wedge according to claim 1, wherein protrusions which delimit a creepage distance are provided on the stem region.

6. A method for closing a slot, comprising at least the following steps:
introducing a slot insulation material into the slot;
introducing a winding into the slot;
deforming the slot insulation material in such a way that at least two opposite regions of the slot insulation material are directed towards a central axis of the slot;
introducing a slot wedge having a stem region and an engagement region perpendicular to the stem region into the slot in such a way that the engagement region of the slot wedge engages with the at least two opposite regions of the slot insulation material.

7. The method according to claim 6, wherein the slot wedge has a closure cap and the closure cap fastens the slot wedge in the slot.

8. The method according to claim 7, wherein protrusions which limit a creepage distance when the slot wedge is introduced into the slot, are provided on the closure cap.

9. The method according to claim 6, wherein protrusions which limit a creepage distance when the slot wedge is introduced into the slot are provided on the stem region.
